(19) United States
(12) Patent Application Publication
(10) Pub. No.: US 2019/0173854 A1
(43) Pub. Date: Jun. 6, 2019

(54) DECENTRALIZED INFORMATION SHARING NETWORK

(71) Applicant: Michael Beck, New York, NY (US)

(72) Inventor: Michael Beck, New York, NY (US)

(21) Appl. No.: 16/198,296

(22) Filed: Nov. 21, 2018

Related U.S. Application Data
(60) Provisional application No. 62/590,054, filed on Nov. 22, 2017.

(51) Int. Cl. H04L 29/06; H04L 9/32; H04L 9/06; H04L 29/08

(52) U.S. Cl. CPC H04L 63/0428; H04L 9/3247; H04L 2209/38; H04L 67/10; H04L 9/0643

(57) ABSTRACT

A payload data can be received. The payload data can be packaged into a first immutable secure container at a first secure system. A new block of a blockchain can be created. The new block of the block chain can be separate from the first secure system. The new block can include a proof of existence of the payload data.

### RELATED APPLICATION

This application claims priority under 35 U.S.C. § 119(e) to U.S. Provisional Patent Application No. 62/590,054 filed on Nov. 22, 2017, and entitled “Decentralized Information Sharing Network that uses Blockchain to Enable Persistent Access, Distribution, and Control Over Data”, the entire contents of which is hereby expressly incorporated by reference herein.

### BACKGROUND

Blockchains can be used to facilitate the development of distributed ledgers. A distributed ledger can include multiple parties connected in a peer-to-peer network. The parties can use consensus to create a verified, immutable, representation of transaction data in an environment where trust between the parties can be limited. In the development of distributed ledger technology, a number of different consensus mechanisms can be used, including Proof of Work and Proof of Stake, whereby ledger balances can be used as an incentive mechanism to enforce the correct behavior of the network participants charged with maintaining the ledger.

### SUMMARY

In an aspect, a payload data can be received. The payload data can be packaged into a first immutable secure container at a first secure system. A new block of a blockchain can be created. The new block of the block chain can be separate from the first secure system. The new block can include a proof of existence of the payload data.

One or more of the following features can be included in any feasible combination. For example, the payload data can be encrypted prior to storage at the first secure system. The proof of existence of the payload data can include a signature, an identifier, and a location of the first immutable secure container. The first immutable secure container can include content metadata, a rights management specification, and at least one secure content holding and can include the payload data. The first secure system can include an access policy that can be associated with the first immutable secure container. The payload data can be received by a first master node. The first master node can select a first storage node from a plurality of storage nodes. The first storage node can be configured to store at least a first portion of the payload data. The first master node can store the first portion of the payload data in the first storage node. The first master node can generate a first assignment indicative of the first storage node. The first master node can receive a plurality of bids from the plurality of storage nodes. A first bid from the first storage node can be indicative of a token associated with the first storage node. The first master node can store a second portion of the payload data in a second storage node of the plurality of storage nodes. The first portion of the payload data can include a first payload datapacket of the plurality of payload datapackets. The second portion of the payload data can include a second payload datapacket of the plurality of payload datapackets. The first master node can generate a second assignment indicative of the second storage node. A second master node can generate a pointer indicative of the first master node.

In another aspect, a system can include at least one data processor and memory coupled to the at least one data processor. The memory can store instructions to cause the at least one data processor to receive a payload data. The at least one data processor can package the payload data into a first immutable secure container at a first secure system. The at least one data processor can create a new block of a blockchain that can be separate from the first secure system, and the new block can including a proof of existence of the payload data.

One or more of the following features can be included in any feasible combination. For example, the payload data can be encrypted prior to storage at the first secure system. The proof of existence of the payload data can include a signature, an identifier, and a location of the first immutable secure container. The first immutable secure container can include content metadata, a rights management specification, and at least one secure content holding including the payload data. The first secure system can include an access policy associated with the first immutable secure container. A plurality of storage nodes can include a first storage node. The first storage node can be configured to store at least a first portion of the payload data. A first master node can be configured to receive the payload data. The first master node can be configured to select the first storage node from the plurality of storage nodes. The first master node can be configured to store the first portion of the payload data in the first storage node. The first master node can be configured to generate a first assignment indicative of the first storage node. The first master node can receive a plurality of bids from the plurality of storage nodes. A first bid from the first storage node can be indicative of a token associated with the first storage node. The plurality of storage nodes can include a second storage node. The second storage node can be configured to store at least a second portion of the payload data. The first master node can be configured to store the second portion of the payload data in the second storage node. The first portion of the payload data can include a first payload datapacket of a plurality of payload datapackets. The second portion of the payload data can include a second payload datapacket of the plurality of payload datapackets. The first master node can generate a second assignment indicative of the second storage node. A second master node can be configured to generate a pointer indicative of the first master node.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc. These and other capabilities of the disclosed subject matter will be more fully understood after a review of the following figures, detailed description, and claims.

### BRIEF DESCRIPTION OF THE FIGURES

These and other features will be more readily understood from the following detailed description taken in conjunction with the accompanying drawings, in which:

FIG. 1 illustrates an exemplary dxChain architecture;

FIG. 2 illustrates an exemplary data storage structure of the dxChain architecture in FIG. 1;

FIG. 3 illustrates an exemplary method of storing information with dxChain using Direct Client Publisher;

FIG. 4 illustrates an exemplary method of storing information with dxChain using DX Enabled Portal;

FIG. 5 illustrates an exemplary method of storing information with dxChain using Trusted Network Publisher;

FIG. 6 illustrates an exemplary scenario where an end user can access dXContainer contents;

FIG. 7 illustrates an exemplary scenario where an end user is denied access to dXContainer contents;

FIG. 8 illustrates an exemplary use case within dxChain network;

FIG. 9 illustrates another exemplary use case within dxChain network; and

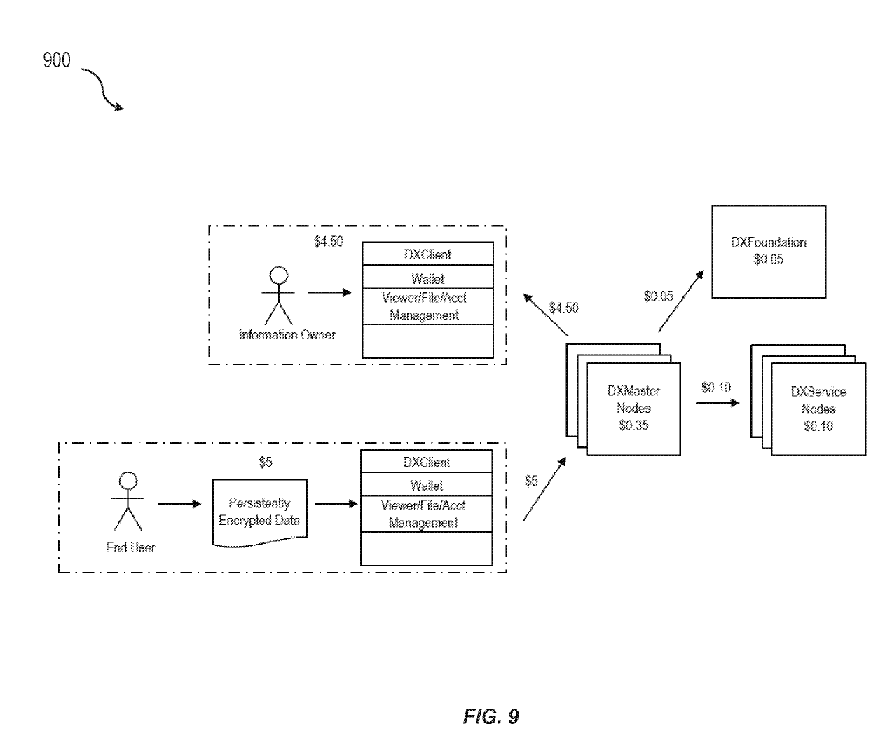

FIG. 10 is a flow chart of an exemplary method for storing data in a dxChain network.

### DETAILED DESCRIPTION

A decentralized blockchain (“dxChain”) is a decentralized information sharing network that can enable persistent access, distribution, and control over data through blockchains. Tokens of dxChain can be transferable between various constituents of the dxChain network. The dxChain can provide a mechanism for maintaining user information, providing controls for tracking and management of distribution of the user information and controlling access to the user information by End Users (e.g., continuous control of access to the user information). The dxChain can allow users and integrators to receive tokens and other incentives for activities that can encourage the growth and success of a network of dxChain.

The dxChain can preserve the privacy of its users. For example, dxChain can provide for privacy and control with respect to data after it has been retrieved by either an intended or malicious recipient. The dxChain can also ensure the privacy of participants associated with transactions that occur against the blockchain and/or the files associated with the dxChain. The dxChain can offer a persistent security model and a robust set of Service Level Agreements (SLAs) for non-repudiation and continuous control over data shared between Information Owners and End Users. The data can be used by other block-chain or traditional application initiatives to embrace new forms of information-enabled transactions and commerce without the need for much additional work or integration.

The dxChain can use DXCoin (DXC) to enable all payments on the network and ensure the integrity of network SLAs and align the economic incentives of dxChain participants. Using DXC can provide dxChain with strength and flexibility that cannot be possible with other payment mechanisms of Turing-complete blockchains.

The dxChain can include several features. With respect to distributed rights management, the dxChain can effectively isolate the roles of publishers, rights managers, and custodians, and can provide owners with control of how, when, and/or where their information is accessed. With respect to persistent security, the dxChain can tie the terms and conditions associated with data and data use to the blockchain. Secure containers in the dxChain can manage the distribution of data. The security containers can manage and/or protect the surety of data regardless of the environment in which it is shared (e.g., whether the data is stored on chain, filesystems, mobile devices, or sent in email, and/or the like). With respect to speed, in some implementations, DXC can target a network-wide SLA of 100,000 transactions a second with a block time of 60 seconds.

With respect to quantum safety, the dxChain can use quantum computing resistant cryptography and signatures to provide trust and security on the platform. The dxChain can use its own key management, DNS services, quantum random number generation, and registry services. With respect to ricardian contracts, the dxChain can provide mechanisms for expressing preferences, consent, permissions, and identity.

With respect to delegated authority, the dxChain can allow information owners to share responsibility in determining the rights of End Users to data on the platform (e.g., with other information owners, publishers, custodians, and/or the like). With respect to human enforcement and audit, the dxChain can protect standards, ensure against malicious actors, create opportunities for accountability, education, and human support, and/or the like With respect to off-chain non-repudiation, the dxChain can identify data as authentic (e.g., with or without direct verification).

With respect to information commerce, the dxChain can monetize the value of data using one-time use contracts for viewing, printing, and/or extracting content. With respect to use and behavioral Incentives, the information owners can receive shares of mined block incentives. With respect to rising tide, the dxChain can creates block-awards that are distributed throughout the network. The dxChain can be GDPR ready. For example, dxChain can enable the secure distribution and adoption of solutions that leverage personal information while respecting emerging privacy and right-to-be-forgotten regimes. The dxChain can allow for open chain/permission-less Network (e.g., easy integration with third-party websites and applications).

Digital rights management (DRM) technology can be found in a number of applications from digital video and music to game distribution, and notions of DRM can evolve with enhanced requirements. There has been an emergence of sealed code delivery and obfuscation that can prevent the malicious modification and tampering of binary applications. In some implementations, DRM as applied to enterprise assets and file systems can give way to reverse proxies, cloud access security brokers, and/or data loss prevention tools that can work in consort to control and prevent the exfiltration of data, and/or the like. Snapchat and other secure messengers can provide time-boxing, and prevent redistribution of privileged and sensitive communications. These solutions can have the ability to create, distribute, and/or verify that content being distributed has not been tampered with.

Digital signatures and/or message digests can be used to certify that information has not been modified (e.g., for well over two decades). Digital signatures can work well in a trusted environment where a central authority can verify the identity of the credentials used to generate them. This solution for non-repudiation can work well in the enterprise, where a root authority or central directory can provide verification of the credentials for parties that can send and receive information. In some implementations, these root authorities would establish cross-certification to establish extended enterprise workgroups when members of two enterprises required the ability to communicate with trusted non-repudiation.

Blockchain can demonstrate non-reputable characteristics of data between enterprises by, for example, being able to maintain tamper-proof logs of distributed, non-reputable data. These blocks of data can be both independently verifiable and cannot be altered as a record of common history without other parties being aware that consensus cannot be met.

While non-repudiation can be a characteristic of the blockchain, trust and anonymity cannot. Blockchains cancan be permissioned (e.g., private) or open (e.g., public), and their content can be verified using a number of mechanism (e.g., consensus algorithms). Blockchains can be private and permissioned to transmit sensitive data with non-reputable standard. For example, a permissioned blockchain is a blockchain that can authenticate a user into a trusted environment for the purpose of establishing authorization to participate in reading or creating transactions that are appended. In some implementations, permissioned chains can be a mechanism by which parties can exchange trusted information on the blockchain without worrying about the information being public.

Enforcing permissions over blockchains can create a single point of authentication or authorization to assert permission over the chain as it can be browsed. Nodes that can mine the chain cancan need to be trusted. Constituents can be known when the content can be accessed. Changes in permissions can be recorded and/or stored in these trusted networks and can be used to provide authentication and/or authorization of users against the content of each chain.

Blockchain-based permissions can be enforced by smart-contracts coded into the blocks of the underlying chains. Smart contracts can be executable programs associated with the processing of specific blocks. In permissioned chains, smart contracts can be used to enforce the permission system with respect to the access to the data. In an enterprise setting it can be challenging to ensure that data cannot always sit on a chain (e.g., when data needs to be emailed, and/or the like). The permissioned user or system can be capable of accessing the data at their leisure. Further, parties who do not have blockchain access can want to access data.

The dxChain can be multilayered. It can be focused on file storage, distribution, sharing, management, control, security and/or monetization. The core of the dxChain network can be a layer of distributed non-repudiation based on blockchain technology. Blockchains (e.g., Bitcoin) can provide avenues to exchange value on the Internet. A number of innovations, have been focused on the ledger, protocols of exchange, and/or the functional natures of various currencies. Turing complete contracts (e.g., as explored by Etherium, EOS, Neo, AEternity, and/or the like) can focus on processing that can occur during the assignment of currency from a sender to a recipient. Projects like ZCash and Dash (formerly DarkCoin) can ensure user privacy in their assignment and receipt of value on these ledgers. The focus of innovation can be on the capabilities to generalize the utility of the underlying chain for specialized applications and the privacy of participants on the chain, such that their individual participation is harder to audit.

Dash has introduced the notion of a tier of master nodes who are responsible for oversight and consensus. This approach is similarly echoed by Steem. In some implementations of Dash and Steem, the master nodes can be responsible for maintaining the integrity of the network as voted and can be responsible parties over the entire network. These networks cannot have the mechanisms for rights assignment and enforcement, off-chain commerce, and/or data exchange. The dxChain can include a distributed system for maintaining the rights-controlled distribution of information, in centralized, decentralized, and enterprise environments. The dxChain can include distributed rights management.

Table 1 provides a summary of implementations of media rights management, personal rights management, enterprise management and distributed right management technologies

| Technology | Description | Example |
|---|---|---|
| Media Rights | A single, centralized, and empowered | iTunes, |
| Management | entity aggregates content from | Kindle, |
| | producers, acts as custodian, and | Netflix |
| | manages the distribution of content | |
| | to known end-users, who have identified | |
| | devices, and pre-determined purposes | |
| | of use. | |
| Personal | An individual sends content (text, images, | Snapchat |
| Rights | and/or the like . . .) to a known party, | |
| Management | with a specific purpose of use or intent | |
| | (limited distribution, duration of | |
| | availability, etc) | |
| Enterprise | Enterprise workgroups and individual | Intralinks, |
| Management | users permission files for distribution | Ionic, Fasso, |
| | on corporate networks to ensure that | Digital |
| | parties cannot print, distribute, or | Guardian |
| | otherwise access content without | |
| | explicit permissions. All parties are | |
| | known within the scope of the | |
| | enterprise or collaborative environment | |
| | that manages the terms and conditions. | |
| | These products can work as enterprise | |
| | proxies or gateways, working in the | |
| | capacity of data loss prevention, catching | |
| | data as parties attempt to send or | |
| | exfiltrate from a corporate network, and | |
| | relegating access to behind a secure proxy. | |
| Distributed | The owners, publishers, custodians, and | dxChain |
| Rights | rights managers of content are different | |
| Management | parties. Each is able to assert their | |
| | respective roles independently or these | |
| | roles can be performed by the same party. | |
| | Content can be secured for distribution | |
| | without knowing the end user, the end- | |
| | user device, or the end-user purpose of | |
| | use. Senders and recipients of data can | |
| | freely collaborate to dynamically re- | |
| | permission data as required. | |

Implementations of dxChain can allow for immutability and consistent Enforcement. For example, terms and conditions associated with data can be bound to data and enforced each time the data is used. Terms and conditions can be bound to data at the time the data is secured. Secured data can be immutable and tamper-evident (e.g., it can demonstrate that data has been tampered with by the End User). All access to data can be centrally and immutably logged. As users share information with a variety of centralized service providers, they can be increasingly at the whims of those providers to provide accurate reporting of the way their individual data can be used.

Implementations of dxChain can allow for empowerment of the information owner. For example, the rights manager and the recipient of data can collaborate to ensure the appropriate and useful balance between privacy and/or service and security and/or availability are achieved. Tensions between Privacy and Service can be well-understood. Many people can feel as if their service in a connected world is tied to their irrevocable sharing of personal data about themselves to large centralized entities and those entities business partners. Similarly, when users have private information they can want to secure, there can be an implicit tension with respect to having that information available when it is most critical. For example, it can be desirable for patients that their health information can be treated as sensitive and can be disclosed only with their consent. However, patients can desire not to be denied timely and effective care from qualified doctors should they be incapacitated. As the use of personal information continues to proliferate, and is increasingly manipulated by new stakeholders and technologies in providing service to end-users, it can be desirable to have a centralized mechanism available to the user to assert their rights and seek rents in return for the use of their data.

Implementations of dxChain can allow for adaptable security and non-repudiation. Different strengths of cryptography can be used and available to parties for different purposes. Cryptography used within the cryptosystem can be flexible and adaptable to the requirements of the application it supports. Key strengths, revocation policies, algorithms, and/or ciphers can be flexible for the purpose of securing information between users. Many cryptosystems (e.g., blockchain-implementing technologies) can be opinionated with respect to these things, and their reuse can be limited. Smart-contracts, however, can introduce the opportunity to scale the repurposing of the same chain ecosystem for different purposes. The supporting cryptosystem used for securing data on the chain can be flexibly supported without requiring hard forks for the secure distribution of content.

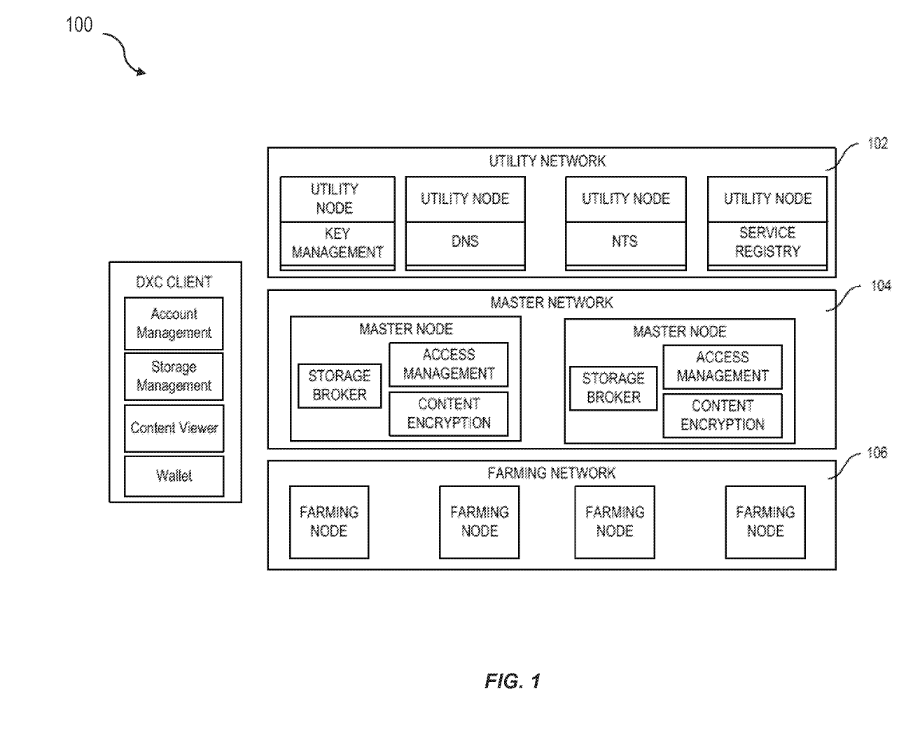

FIG. 1 illustrates an exemplary dxChain architecture 100. The dxChain can include multiple tiered (e.g., three-tier) decentralized network. In one implementation, the dxChain can include a service network 102, a master network 104, and a storage network 106. The storage and master network can provide two types of storage: the storage network can hold user available data that can be used by the master network to hold configuration desired for sharing keys between multiple clearing environments. The user environment for data can desire non-repudiation (e.g., the master network can require throughput and availability). The service network can depend on the master network. Master network nodes can participate as dxService Nodes. The high-level components of an example dxChain Architecture can be as follows:

The dxChain architecture can include dxStorageNode that can be responsible for storing and mining information regarding interactions, preferences, and content on the network. The dxStorageNodes can pledge storage for the benefit of the network. The dxStorageNode can be operated by a user and can participate on the dxChain Network.

The dxChain architecture can include the dxMasterNode that can be responsible for performing the content permissioning and permission enforcement on the network. These nodes can be operated through a nomination and/or voting process.

The dxChain architecture can include dxServiceNodes that can provide core utility services to the Master Nodes (e.g., to ensure that Master Nodes do not need to provide core utility services for themselves). The dxServiceNodes can provide functions regarding key management, time functions, random number generation, and/or network credentialing. These nodes can be operated through a nomination process.

The dxChain architecture can include dxClient that can allow the users to communicate with the dxChain network. Users can store their tokens, manage their accounts and/or privacy and/or notification settings, manage their files on the dxc storage network, receive notifications, message with other users, access persistently encrypted files and/or data content. The components of the dxClient can be packaged together or used independently. For example, for users who are interested in the ability to manage their tokens and transactions of the storage network, the other components of the wallet cannot be desired. Users looking to share privacy-protected containers with parties not on the network can be interested in the viewer component of the wallet.

The dxChain architecture can include dxContainer that can allow for storing data in a non-reputable format, and for providing layered non-repudiation over the chain transaction. This format can ensure secure distribution and control over data. Immutability of opcodes can provide a space to store immutable data. Layering non-reputable characteristics in a structured container can allow the extension of functionality beyond the view of storing data within opcodes and/or in loosely associated storage. Further, while blockchain storage protocols can encrypt and shard data to provide security, when reassembled there can be no security over the reassembled format. The dxContainer can provide persistent security, allowing for the enforcement of a security model, even when the data is not retrieved by the party committing the data. The dxContainer can be used to store structured and/or unstructured data. It can enable information-based commerce. It can similarly store sealed programs that can execute within the scope of the user's wallet.

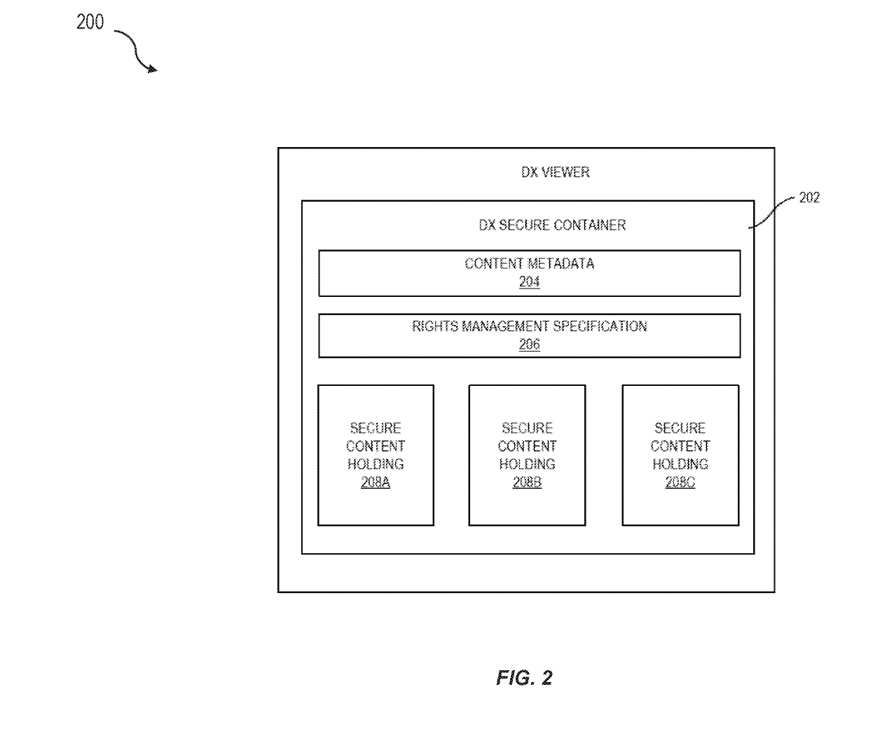

FIG. 2 illustrates an exemplary DX Viewer 200 that can allow access (e.g., exclusive access) to dxContainer 202. The container format can ensure that dxContainers can be opened from within a dxClient Viewer and/or other trusted application that is recognized by the dxChain Network. The dxContainer 202 can include content metadata that can provide for intelligent management and processing of user requests. The dxContainer can also include a Rights Management Specification 204 which can enforces a consistent structure across multiple container uses and supported operations. The operations can further include Secure Content Holdings 208A-C that can be bound with authorization, purchase, and/or other requirements to facilitate use of enclosed, encrypted contents that can take the form of any standard format (e.g., unstructured content, XML, JSON, images, application code, and/or the like).

In some implementations, blockchains can rely on data being anonymized or sanitized to preserve privacy. However, most private data, (e.g., healthcare data) can be reidentified from common sources, which can prevent this information from anonymity. In considering the risks of communicating even deidentified data on a public blockchain, one can consider the likelihood of malicious nodes seeking to participate in a privileged capacity to gain unfettered access to permissioned data, which can provide them with irrevocable value for short-term participation. In some implementations, even if public blockchains suffice for communicating patient data in some cases, there can be many places where this infrastructure is not immediately congruent for adoption (e.g., when dealing with dependencies that rely on legacy applications and strongly defined custodial relationships).

For these purposes, the dxContainer Structure can offer both flexibility and security. In some implementations, the dxContainers can include many different, but interrelated types of content, including text, images, and/or audio. In some implementations, the dxContainers can be delivered using many methods of distribution (e.g., Internet, network, removable storage, portable device, and/or the like) without breaking underlying security models. In some implementations, dxContainers can support multiple types of encryption and varying encryption strength, and can, for example, allow for a blend of both industry-standard PKI credentialing and/or blockchain credentials to authenticate and authorize recipients to access secure content holdings. In some implementations, dxContainers can verifiably maintain their non-repudiation and immutability characteristics independently of a blockchain infrastructure, assuring that recipients and End Users can gain easy assurance that content is authentic from its source.

In some implementations, the dxChain system can overcome tensions between the security of data and its availability, as well as tensions that can exist between the provisions of privacy and service that can exist in data sharing systems. In some implementations, the dxChain can balance desires for information security and access by enforcing persistent controls over data content.

In some implementations, dxChain can effectively control what End Users can do (e.g., the abilities to view, print, save, copy and/or paste data, the ability to restricts circulation based on date, time, IP address, geography and device, the ability to control use on basis of a currency or cryptocurrency transaction, bound to the content, and/or the like).

In some implementations, the dxChain can give data owners and/or custodians continuous control over the information they distribute (e.g., implicit and explicit relationships between end users and content can assist in constructing robust authorization schemes; access privileges can be added or revoked at any time, access to secure information is persistently tracked; data integrity can be ensured and verified each time data is accessed, both through blockchain and independently; content can be disabled and users notified to changes and updates, when content is no longer relevant, data; owners can engage content publishers and custodians to facilitate the transfer and aggregation of their content for value-added applications without losing their ability to assert their rights to manage content access, receive monetary payments, or revoke privileges; because it is a decentralized system for both data storage and access, end-user nodes cannot need to be online to provide explicit permissioning at the time access is required, and/or the like).

In some implementations, the dxChain data distribution format can be different from enterprise security, rights management, and/or data-vault technologies, as well as other private data or data vending solutions. For example, dxChain can secure 1^{st}, 2^{nd}, 3^{rd}, . . . , n^{th} order distribution of data, enforcing strict controls over data access and use, beyond the initial point of receipt. In some implementations, using secure containers and metadata relationships, dxChain security can be bound to the data, enabling full security at all times, in all locations. In some implementations, enterprise security and data-vault technologies can focus on trust of authorized users, offering little (e.g., no) control over secondary distribution of data such as screen capture, sharing, printing, forwarding, and/or the like. In some implementations, dxChain can provide for improved protection for data content from inside and outside attack vectors, including cases where data content is distributed outside the enterprise. In some implementation, dxChain can provide for flexible, relationship-based permissions that can ensure as-intended, context-sensitive access to data, even after in the possession of an intended recipient.

In some implementations, data can be independently secured and easily identified as authentic, independent of zero knowledge proofs (e.g., no reliance on trusted application or network configuration to ensure data security). For example, non-repudiation characteristics of dxChain data distribution format can make it easy to determine information has not been altered. In some aspects, where zero-knowledge proofs can require primary information to establish the correctness of a committed value to the blockchain and/or allow for the value's replication and/or refutation to establish authenticity, dxChain can secure distribution of data from trusted publishers and custodians in a way that can obviate the need for zero-knowledge proof calculation.

In some implementations, the dxChain can allow for distributed trust model. For example, Authorized parties cannot need to be known in advance by data content Owner/Custodian or Data Content Publisher in advance of content distribution. In some implementations, other data vending solutions can provide one-off exchange of information to a trusted entity or party. In some implementations, trust associated with trusted parties can change. For example, businesses can be acquired, information security policies can change, employees can maliciously or unintentionally exfiltrate or misappropriate code (e.g., by losing removable media, having portable devices, becoming victim to phishing or malware, and/or the like), and/or the like. Additionally, or alternately, information can be hard to price (e.g., data vending environments cannot necessarily reveal the true value of data beyond the initial point of collection). It can be much easier to price the initial need for data than to price the initial and every subsequent need for data within a consumer-to-enterprise transaction.

In some implementations, the dxChain can allow for delegated authority. For example, accounts can represent an individual or an organization that governs the relationships between multiple individuals. When creating an account against a dxMasterNode, a party representing themselves as the head of an organization, can submit additional information to bind information regarding the organization's account. All account data can be stored as immutable within a versioned chain. Changes to core account data can be differenced as point-in-time records that are associated with the account and subsequent user access.

In some implementations, the dxChain can allow for dxRightsManagement (DXRM). DXRM can include a trustless rights management approach, which can effectively remove the need for Information Owners, Custodians, and Publishers to be the same party in order to effectively assert their rights over distributed data, or control, track, or manage the data's distribution. In some aspects, DXRM can work without the use of a content-specific, key escrow or password-authenticated key retrieval system, which has been shown as vulnerable in the past. In some aspects, the DXRM can work through the distribution of clearing responsibilities, such that data is never locked with a single party having access to specific decryption keys, requiring quorum of dxMasterNodes to authorize content access. In some implementations, the dxChain approach to this problem can be based on an implementation of Shamir's Secret Sharing scheme, which can be a quantum computing-resistent quorum based mechanism for using a minimum number of nodes to unlock underlying data.

In some implementations, dxChain can enable a number of fully distributed rights management applications that displace traditional custodial services as well as empower a new generation of applications that are privacy preserving. Table 2 below provides some exemplary implementation of dxChain systems.

| Example | Tradtional (Centralized) | Distributed |
|---|---|---|
| Music Sharing | Music and Books published | Artists control their |
| and | through services like | own publishing and |
| Publishing | Kindle, ITunes, Spotify, | distribution, easily |
| | and SoundCloud. Content | collecting payment every |
| | aggregators and publishers | time their content is |
| | collect fees and pay artists. | accessed. |
| Enterprise | Corporate security | Policies over data can |
| Rights | environments authorize | be dynamically added or |
| Management | known recipients to use | removed-distributed data |
| | data at the time the | can be disabled, even |
| | data is encrypted. | after it has been received |
| | | by an intended recipient. |
| Personal Rights | Messages controlled | Messages encrypted and |
| Management | through Snapchat - files | managed by the sender, |
| | and images shared on | not a central service, |
| | Google+ and Facebook. | ensure that the encrypted |
| | Timeboxing, etc | information is always |
| | facilitated by a single | private. |
| | custodian. | |
| Medical | Information centrally | Patients freely control, |
| Records | managed and controlled | who can see what data |
| | by insurance companies | when and where. |
| | and doctors. | Information persistently |
| | | secure, regardless of |
| | | where and how it is |
| | | accessed. |
| Property Records | Files are stored in | Files stored in |
| and Personal | folders with minimal | electronic format, |
| Documents | security-hard to | sharded and always |
| | retrieve when needed. | available. |
| Appraisals | Appraisal files are | Owners easily keep and |
| | stored in files that | control appraisal files |
| | are hard to authenticate. | to facilitate unbrokered |
| | Provenance is stored in | sale of high-value |
| | databases owned by auction | property. |
| | houses. | |
| Service | Service records are | Owners maintain and |
| Records | maintained by dealerships | control service records, |
| | or centralized services | and can share data freely |
| | (ex. Carfax), for high | without centralized party |
| | value items, it is | required to verify the |
| | difficult to share records | authenticity of |
| | with prospective private | documents provided. |
| | buyers. | |
| Consumer | Customers receipts are | Consumer purchases can |
| Purchases | stored in paper or sent | be appended to private |
| | via email. | transaction |

Innovations in these ecosystems can open the development of a wide suite of tools and utilities for developers and enterprises to innovate.

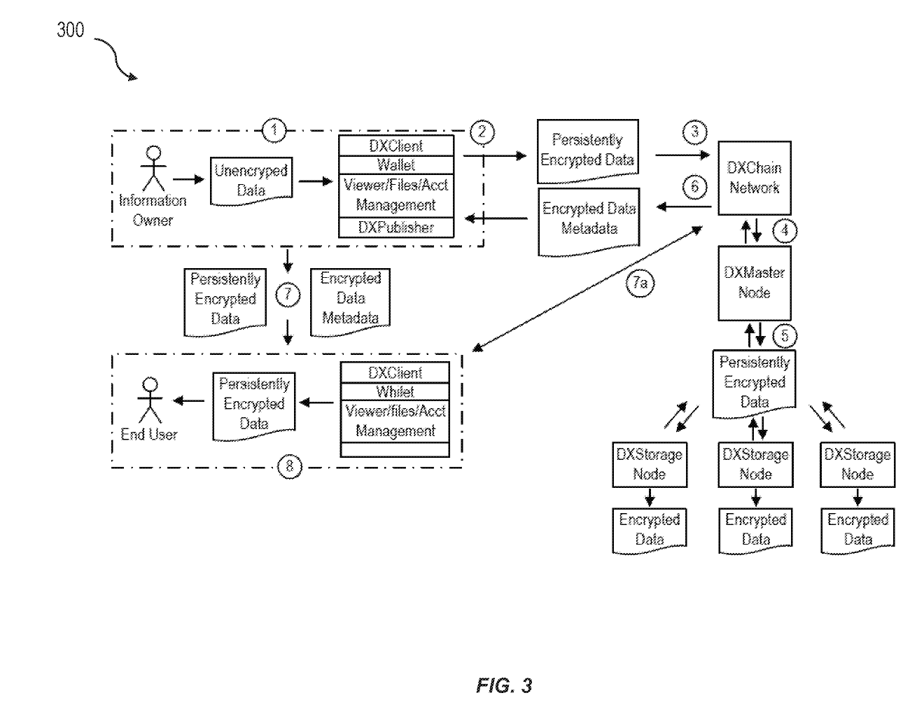

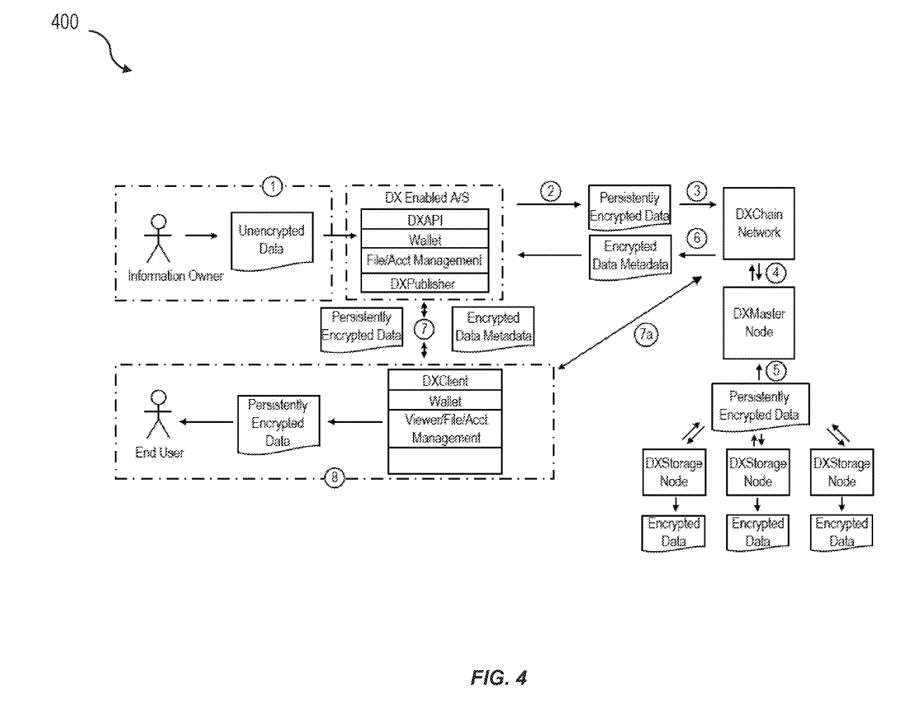

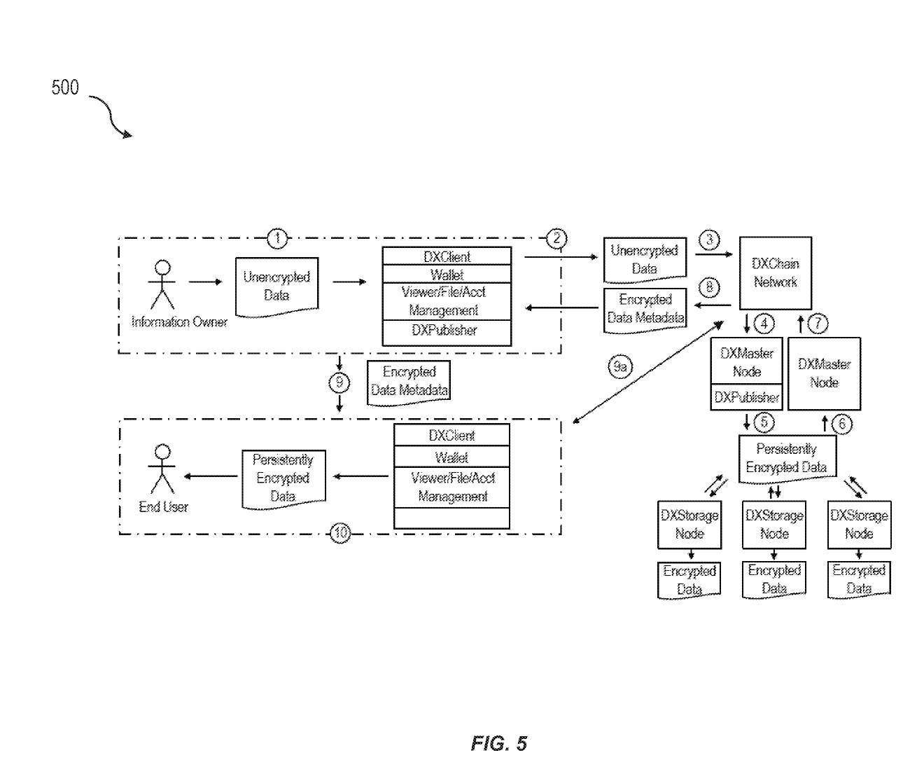

FIGS. 3-5 illustrate exemplary methods for storing information with dxChains (e.g., by the information owner). These exemplary methods illustrate flows of data and collaboration of dxChain Network components when an Information Owner stores data. FIG. 3 illustrates an exemplary method of storing information with dxChain using Direct Client Publisher. FIG. 4 illustrates an exemplary method of storing information with dxChain using DX Enabled Portal. FIG. 5 illustrates an exemplary method of storing information with dxChain using Trusted Network Publisher.

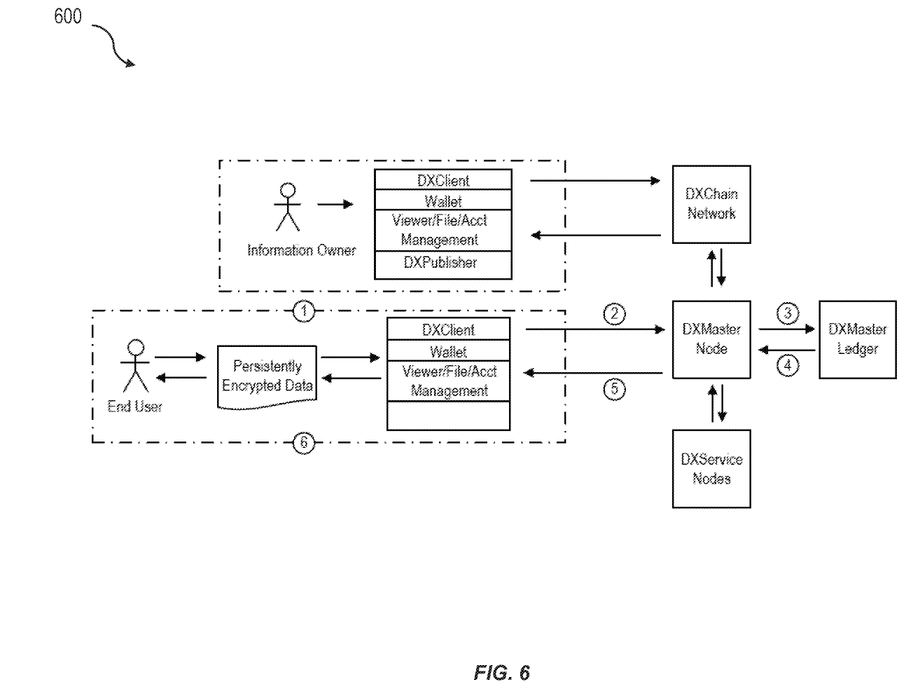

FIG. 6 illustrates an exemplary scenario where an end user can access dXContainer contents.

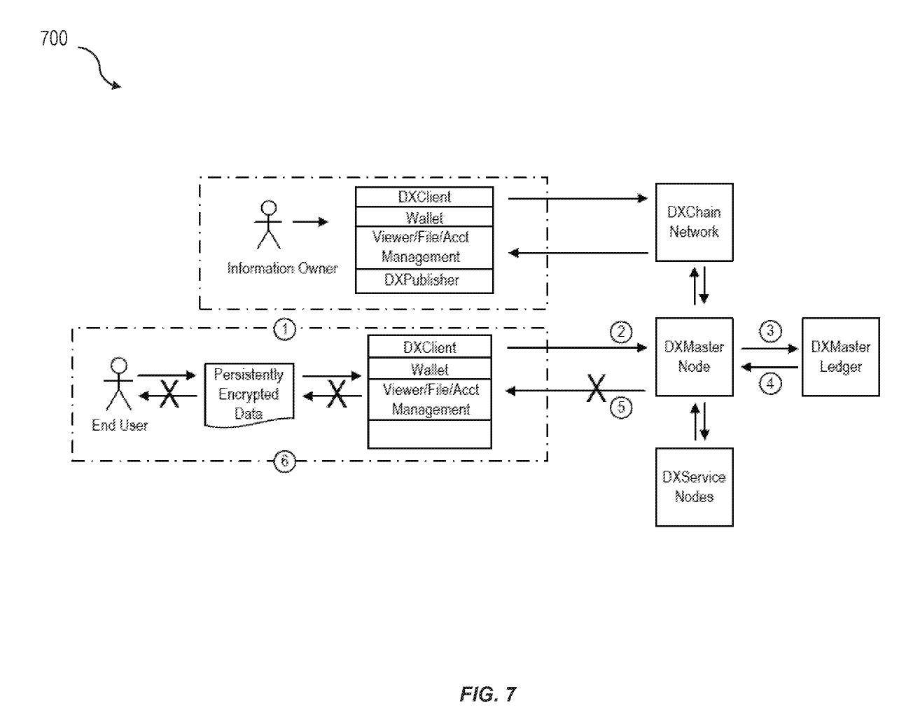

FIG. 7 illustrates an exemplary scenario where an end user is denied access to dXContainer contents.

In some implementations, the dxChain can allow end users to request access to the dxContainer of an Information Owner. For example, the End User (e.g., who cannot have access to the dxContainer content) can receive a dxContainer from an Information Owner. The End User can make an access request through the dxChain Wallet/Viewer, requesting desired access privileges. The access request can be forwarded to the Information Owner via a secure messaging system that can be hosted with dxChain network. The Information Owner can approve the access request and the End User can now able to access the content for which he/she has been approved. These features can be securely implemented through API integration with the dxChain network into a third-party application who can work as an Information Publisher, Custodian, or Intermediary.

In some implementations, the dxChain can allow End User to request additional access to the dxContainer of an Information Owner. For example, the End User can currently have a copy of the Information Owner's dxContainer, but cannot have received access to all content and/or certain desirable content. The End User can make an access request through the dxClient, requesting desired, additional access privileges. The access modification request can be forwarded to the Information Owner via a secure messaging system that can be hosted with dxChain Network. The Information Owner can approve the access modification request and the End User can now able to access the content for which he/she has been additionally approved. These features can be securely implemented through API integration with the dxChain Network into a third-party application who can work as an Information Publisher, Custodian, or Intermediary.

In some implementations, the dxChain can allow the Information Owner to revoke End User Access to a dxContainer in the End User's Possession. For example, the Information Owner can provide a dxContainer file to an End User to facilitate a limited-scope relationship. The Information Owner can revoke the End User's future access to the dxContainer content by removing and/or modifying the End User's existing access privileges from controls available through their dxClient. These features can be securely implemented through API integration with the dxChain Network into a third-party application that can work as an Information Publisher, Custodian, or Intermediary.

In some implementations, the dxChain can include a monetary system. The dxChain monetary system can include several components. The monetary system can include dxChain's Ethereum ERC20 Token contract (DXE) which can be used for currency raise through the initial currency offering (ICO) to establish the value of DXC, the primary currency of dxChain. The monetary system can include dxCoin (DXC) which can be the primary token used for powering the dxChain network. The monetary system can include dxMasterNode token (DXM) that can be exchanged and maintained by dxMasterNode participants. The monetary system can include dxPower (DXP) that can be an incentive shared between the DxMasterNodes and the network. DXP can have no direct monetary value.

In some implementations, for example, at pre-ICO, dxChain Network tokens are based on the ERC20 token. They can be referred to as DXE token, which can be used for initial currency distribution and for activities associated with building and growing the platform until the main network becomes available. The DXE token can be a contract on Ethereum that can be used within any wallet that uses the ERC20 token standard.

In some implementations, upon launch, the dxChain Network can use two currencies that can serve as utility tokens in the system: DXC and DXM. The dxChain's core currency token, DXC, is at the network's base. DXC token can be traded on multiple cryptocurrency exchanges and markets, as well as being used as payment for goods and services. DXM can be the derivative token use to provide incentives to dxMasterNodes. DXC and DXM can be exchangeable. DXC can be used to trade with other currencies.

In some implementations, owners of DXC can trade for DXM as they seek to become Master Nodes. DXM cannot be transferred or traded freely, but the account owner can choose to withdraw DXC from the DXM account in weekly payments (e.g., out to 1/30th the account's total DXC). The Master Node can lose its proof of stake in proportion to the amount of currency withdrawn. DXM can be traded with dxServiceNodes in exchange for valuable services to the DXMasterNode network. At the point where the dxServiceNodes operate, they can provide a Proof of Burn, destroying a portion of the currency (e.g., 50% of the currency) they can receive an estimated portion (e.g., 2.5%) of each transaction value worth of token. The dxChain can host an internal market in the dxChain blockchain, and integrated in the dxChain website where DXC can be traded with DXM and vice versa. While DXM to DXC conversions are a slow process, DXC to DXM conversions can be faster.

In some implementations, dxChain can be a storage network. Nodes can be compensated for the storage they provide and the other features of the network they facilitate. Nodes can append user data locally using a mining process. For example, for successfully mining data, the dxStorageNodes can receive 45% of the block value being mined, the dxMasterNodes can receive 35% of the value of the network, and the development community can receive 10% of the proceeds.

In some implementations, bandwidth can be logged at the nodes. The service can provide a storage calculator. Usage can be calculated each month. The initial set-up can be 25 GB and 25 GB bandwidth. Users cannot be rate limited within the first 12 months.

In some implementations, as dxMasterNodes are responsible for mining transactions, they generate block incentives in return for their efforts, which are, in turn, shared back with other members of the network. In some implementations, Information Owners can enable commerce transactions against components of the data they manage on the network. In this case, the Information Owner can specify a price for the value of access of data using one of many potential cryptocurrencies. On these transactions, the network can share in the value of a commission on the transaction fee that is collected by the Information Owner.

In some implementations, the dxChain can produce DXC. For example, DXC can be produced to pay dxStorageNodes and dxMasterNodes. Users of the dxChain network can have control of their DXC similar to how they have control of their Bitcoin or other currencies. The users can control their own accounts and passwords, which are completely client-side. The users can have free, unrestricted access to the dxChain. In some implementations, users can change DXC into Ethereum, Bitcoin, and USD using a typical cryptocurrency exchange. In some implementations, dxStorageNodes are analogous to mining pool operators on Bitcoin; they can be responsible for production and security of the network. In some implementations, dxMasterNodes can produce untradeable DXM incentives which are distributed to dxMasterNodes and dxService nodes, and convertible to DXC.

In some implementations, the dxChain can allow for earning Digital Tokens on DX. By storing content submitted to the dxChain network, one can earn DXC in return for storage and incentives from the DXC network. Storing content can occur in BTC, ETH, USD, or DXC. In some implementations, the network can continually create digital tokens. Most of the newly created tokens can be transferred to dXStorageNodes and dxMasterNodes, while the remainder can go to dxChain Network, and shared with Information Owners in proportion to the amount of data that is stored and dxMasterNode incentives that have been relegated to those accounts. In places where the Information Owner has set or agreed to a transaction value for their data, the seller of the data can receive some value.

In some implementations, community participation can be regulated, where individual contributions to the community can help in determining the weighting of a user's participation in network shares of mined currency. The dxChain can have a similar mechanism, but DXPower can be used instead by the dxMasterNodes to incentivize behavior of the Information Owners. In some implementations, the more DXPower an Information Owner has, the larger their percentage of block distributions.

In some implementations, accounts are created with nominal dxPower. The dxPower cannot be purchased and can be used for encouragement and discouragement of behavior. For example, a dxMasterNode can want to incentivize more open sharing of consumer retail data, so it can provide a power reward to participants who share this type of data on the network, such that they can participate in the mined block rewards of commerce related transactions in a higher proportion than parties who do not share their data in similar fashions. As such, dxPower is determined by the identified goals or metrics of the respective peer participants of the dxMasterNode network for which stored containers are being rated. The dxPower incentives provided by a dxMasterNode can occur at two points in the lifecycle of an Information Owner's content commitment to the dxChain Network.

In some implementations, at the time of the packaging process, data submitted for packaging at a dxMasterNode can be processed on a deidentified basis against the behaviors of other participants on the chain. For example, in a healthcare setting, as submission occurs, preventative care, plan of care, and/or the like, can be incentivized with points associated with the accumulation of data that meets the objectives of the dxMasterNode tasked with managing the publication of the Information Owner's content. In this case, the goals set by dxMasterNodes can be determined by consensus to ensure that all participants within a value network conveying dxContainer data behave normatively with respect to information being packaged.

In some implementations, as transactions clear against the dxContainers, dxMasterNodes can observe preferences for data sharing and visibility of certain classifications of data shared on the network. The dxPower incentives can be assigned by dxMasterNodes on the basis of sharing volume, selected clearing parameters, and/or other characteristics of the data distribution and access process.

The dxPower incentives can work in several implementations. For example, in financial containers that can have incentives for users submitting supporting transaction documentation. For example, in Healthcare containers that can have incentives for users submitting documents that follow plan of care. For example, in Vehicle service containers that can have incentives for users following regular maintenance payments. For example in Consumer retail containers that can have incentives for consumers who make their information more visible or offer more favorable pricing for parties seeking access to their data.

In some implementations, blockchains can be designed. In some implementations, dxChain uses Data Contracts, which are smart contracts written to the dxChain blockchain. These contracts enable DX Information Owners to use space provided by dxStorageNodes with a well-defined set of rules that can be automatically enforced. The dxStorageNodes can require compute power, storage capacity, and bandwidth. These nodes can be economically incentivized by token rewards paid as a function of their contribution of resources.

In some implementations, the dxChain users can establish an allowance, for example, a pre-paid amount of DXC meant to pay for storage and bandwidth costs for the total established duration of the contract (e.g., 13 weeks, or a three months). This allowance can be arranged as part of fixed-fee services that can beprovided on top of the dxChain Network. The allowance can get locked in the wallet component of the dxClient, which can help the Information Owner delegate to the dxMasterNode to pick optimal dxStorageNodes according to their scoring on the basis of established reputation to the network. In some implementations, heartbeats and ping results can be stored on the dxMasterNode network to ensure that all dxMasterNodes know the shared reputation of nodes being written to for determination. In some implementations, the dxChain can attempt to throttle commits to farmers showing 15% or less storage availability. In addition to reliability, dxMasterNodes can accept dxStorageNodes on the basis of Information Owner preference for nearest (e.g., fastest response) clustering, dispersed (e.g., most diffused) clustering, highest reputation clustering, and/or the like.

In some implementations, the file contract can be signed by the Information Owner and the dxMasterNode and can be submitted to the blockchain for bidding by dxStorageNodes. These dxStorageNodes, as a guarantee of good intentions, can lock up an amount of tokens as collateral. The size of the collateral can be setup manually by the dxStorageNode, but higher collaterals can ensure a higher scoring during the dxStorageNode selection process. The dxMasterNode can select the dxStorageNodes it will be assigning content to and the dxMasterNode and each of the dxStorageNodes can sign the contract. At the time the contract is unsettled, the dxStorageNodes can be unaware of each other, only their own commitment to the dxMasterNode. Only dxMasterNodes can have the ability to identify the dxStorageNodes used for block assignment. For example, the block assignment can be indicative of the dxStorage node and data stored in the dxStorage node (e.g., data from the Information owner).

In some implementations, the Information Owner can upload and download files freely while files can be stored on the network under contract. The dxStorageNode pricing updates cannot affect current contracts. Data transfer can be done as a direct connection between the Information Owner and the dxMasterNodes, where the dxMasterNodes can be responsible for federating data from the dxStorageNodes. This is considered an advantage to networks that establish direct peer-to-peer connections between an Information Owner and his supporting dxStorageNodes (files are not included in the block-chain).

In some implementations, the dxContainer files can be placed through an encryption process and sharded. For example, users can store data on the network as if thinking of the network as an extended file system, or as a system for controlling the exfiltration of data more generally. Instead of sharding files across multiple recipients, the client can both encrypt and sign data (e.g., in a PKCS-7 compliant envelope). This envelope allows for the creation of an index independent of the content and can provide for a layer of data authenticity. It can allow for the specification of how the data is encrypted, and the signature of the publisher of the data to the network. The content of the envelope and the envelope are passed to a dxMasterNode. The dxMasterNode can then poll the network for available dxStorageNode.

In some implementations, when a user uploads a file to the network, the file can be sent to a dxMasterNode. Data can be encrypted by, for example, the AES265 algorithm and stored with, for example, Reed-Solomon encoding, and can ensure internal consistency and redundancy during retrieval. Current target redundancy can be 5×.

In some implementations, during the contract, the hosts can submit Proofs of Storage (e.g., a hash of the stored shard, hash of the network timestamp, index of the stored shard, and/or the address of the network storage node.) to the dxMasterNodes to demonstrate a) they are online, b) they still preserve the Information Owner files intact. Hosts can be required an uptime of 97% through the duration of the contract or they sacrifice their collateral on the contract.

In some implementations, if during the contract duration, some dxStorageNodes go offline, and the total redundancy drops below 3×, new dxStorageNodes can be recruited for the contract and data can be uploaded to them by the dxMasterNode. File repair can work offline (e.g., the Information Owner does not need to be online to allow the repair, because the network knows what shards are required for maintenance).

In some implementations, depending on what happened during the contract window, there can be different possible outcomes. In one aspect, if the Information Owner did not upload any file, the Information Owner can receive his allowance back, but can pay the fees (e.g., host is ensured to not pay any fee this way if Information Owner did not use the contract). In another aspect, the Information Owner can upload the files and the host can achieve the target uptime. The Information Owner can receive the unused part of his allowance and can pays the fee corresponding both to the allowance and the collateral. The dxStorageNode can receive the payment for storage and bandwidth and the entire collateral back. The dxStorageNode does not pay any fee. In yet another aspect, the Information Owner can upload the files, but the dxStorageNode cannot achieve the target uptime. The dxStorageNode can lose the full collateral corresponding to the amount of storage uploaded by the Information Owner, and cannot receive the payments for bandwidth and storage. The losses cannot be paid to the Information Owner, but instead burned by the dxMasterNode.

In some implementations, contracts on the dxChain network can be auto-renewed, unless otherwise specified by the Information Owner. The Information Owner cannot need to be involved in the autorenewal of their contract. The dxMasterNodes can have authority under agreement between the Information Owner and the dxChain Network to oversee file contract maintenance, but associated payments for contract value can need to be up-to-date for the renewal to occur. Current pricing of dxStorageNodes can be applied to the new contract. New dxStorageNodes can be selected to replace participants in the prior contract that are no longer available. If the contract is terminated without renewal, the files can be deleted from the dxStorageNodes as condition of their final payment using a publicly verifiable mechanism of assuring files have been deleted.

In some implementations, the dxContainer can be a flexible component for storing content distributed either on or off of a blockchain. The dxContainer can be lightweight, and can permit content to be easily cached over the blockchain network or shared in a way that only the relevant information is loaded by the client at the time access can be desired.

In some implementations, the dxContainer can include static data (images, structured data, non-structured data, sound, movie files, and/or the like). This static data can also include executables. The executables or scripts can be demonstrated as non-reputable by their location on the network and/or association with the container, but can be executed local to the user machine. By separating out the executing program to the scope of the user machine instead of the network, the network cannot be responsible for mining code in process of other computational tasks, and the software execution can be managed by the same rights-management visibility as the rest of the container.

In some implementations, the dxContainer can have a logical structure, and a physical structure that can manifest through calls to the network. In some implementations, the client can remarshal the content, and can make dynamic calls back to the network to reassemble the content within the scope of the container. In some implementations, opening container content can occur through reference to the dxMasterNodes, which can establish the relationship between the requesting security principal (user or system) and the data content subject (the owning subject of the object being requested for access).

In some implementations, the dxChain Network can be a three-tier network. The dxStorageNodes can be responsible for creating new blocks. The second tier of the network can include dxMasterNodes. The dxMasterNodes in the dxChain environment can encrypt/package content for wallets who do not choose to package content for themselves, and can clear submitted transactions to the network for access to content in dxContainers. By default, a dxMasterNode can address the network as a building node, a clearing node, and/or both, and can be certified and trusted for the purpose of its chosen activities.

In some implementations, the dxMasterNodes can maintain a full copy of the blockchain, provide user registration and/or verification services, and can be willing to submit to ongoing dxFoundation approval and audit. The dxMasterNodes can also maintain minimum balances of DXM in their accounts. That collateral can be spent at any time, but doing so, can remove the associated dxMasterNode from the network. Because dxMasterNodes provide vital network functions, the block reward can be split between dxStorageNodes and dxMasterNodes (e.g., with each group earning 45% of the block re-ward and the remaining 5% of each block can reward funds to the budget or treasury system).

In some implementations, transactions at the application layer can be anonymized by the dxMasterNodes as they are written to the chain nodes. Recovery of transactions can occur through the dxMasterNodes. In some implementations, the dxMasterNodes can reference Ricardian contracts associated with persistent permissions for access to content and observe those permissions when clearing content within a container. Logs of interactions can be stored on the blockchain that can be maintained by dXStorageNodes. This can provide both point-in-time information regarding the availability and permissioning of content at the time the content is accessed, as well as full activity of users against the content.

In some implementations, organizations and individuals can both choose to operate dxMasterNodes. The dxMasterNodes can be designated in several ways. For example, they can be nominated by dxStorageNodes on the network, they can be certified service providers that can be credentialed by dxChain to perform a specific class of rights management service to the users of the application environment, and/or the like. In some implementations, because all dxMasterNodes have the ability to clear and access the respective metadata associated with granting access to all containers, dxMasterNodes can be segregated from the general dxMasterNodes on the dxChain Network to the extent that they provide regulated services. For example, for conveying health information among covered entities, dxMasterNodes can need to be considered HIPAA business partners for those covered entities and the storage environments that store related data can have to be similarly considered HIPAA business partners for the purposes. In contrast, conveying health information in a consumer-directed environment (as opposed to a provider or payer integrated environment) cannot require HIPAA compliance, so these dxMasterNodes do not need to warrant themselves as such.

In some implementations, while dxMasterNode operators can choose to clear all associated content on the network, some dxMasterNodes can have an affinity for a specific type of content (eg: music, custody documentation, health records, and/or the like). These service preferences can be expressed to the network as part of the established Ricardian contract template submitted for support by the network. In some implementations, the dxMasterNodes can be responsible for clearing, journaling, and/or sharding content across the dxStorageNode network. As a result of their activity, they can receive a portion of the DXC earned (e.g., through competition). The dxMasterNodes can enter into explicit contracts that can be associated with their reputation and reliability with the dxClient. The dxMasterNodes that can specialize in certain types of containers can be considered more than other nodes who can advertise to the corresponding wallets. The dxClient can request information about the dxMasterNode's uptime, supporting service nodes, and/or clearing rate. Consensus between dxMasterNodes can be established using, for example, delegated Byzantine Fault Tolerance (dBFT). The dxMasterNodes can work as a broker to the storage network, and can be paid in referrals (e.g., portions of the block-awards associated with distributing content to the block farmers). These rewards can be paid to dxMasterNodes in the form of DCM, which is not openly tradable. In some implementations, the dxMasterNodes don't have the ability to dictate the underlying storage costs observed by the network, but do receive a contracting fee for their reliability. In some implementations, dxMasterNodes can additionally post hashes of attestation to other chains outside of the dxChain Network. In some implementations, dxMasterNodes participate in a network using, for example, delegated Byzantine Fault Tolerance, where consensus can be scheduled for processing, for example, every 3 seconds. In some aspects, 67% consensus can be desired for the journal entries of the dxMasterNodes to be accepted by the rest of the network. Block-awards can be generated by the dxMasterNode network in the form of DXM and shared with the dxServiceNodes. This can provide active incentive outside of profit sharing in the DXStorageNode and commerce clearing activities.

In some implementations, dxServiceNodes are shared, trusted nodes available to the DXC network. They can be managed by the dxChain global registry and maintained by known and identifiable stakeholders who can provide their declared services to the network under SLA. These actors can publish in a directory that can be known from which parties configuring their nodes can reference for best practice.

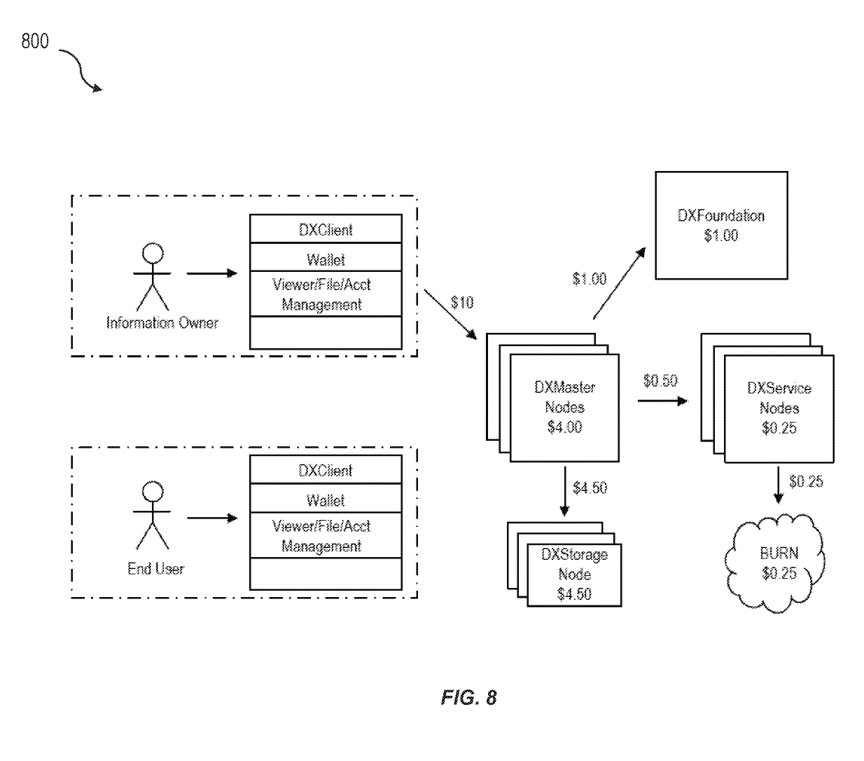

In some implementations, service nodes within the dxChain network receive incentives from the dxMasterNode network in the form of DXM payments and maintain their viability on the network through a combination of proof of burn and fixed participation. FIG. 8 illustrates an exemplary payment within dxChain network. For example, a 5% contribution of DXC can be paid to the Service Nodes from which 2.5% is burned. In this example, for a $10 DXC storage contract, $6.50 DXC goes to the storage nodes, $3.50 DXC goes to the dxMasterNode in the form of an exchange to DXM, $0.50 DXM is allocated to the Service nodes required in the dxMasterNode's performance of work, and $1.00 goes to the dxFoundation. Each service node, for example, can burn 50% DXM that it receives for its work. This can create constant deflationary pressure on the system. In some implementations, if there are fewer dxServiceNodes than dxMasterNodes and fewer dxMasterNodes than dxStorageNodes, the result can be that the value of service tokens inside DXC is stronger than their relative value in other currencies that do not have similar deflationary pressure over their use.

In some implementations, specific service node types in the DXC network can include one or more of the following. Notification servers can provide SMTP and SMS services to dxMasterNodes. Random Number Generation Servers can provide Quantum Random Services to dxMasterNodes. Key Management Servers can provide hardware cryptography functions on behalf of dxMasterNodes and support for work. Spacial and Collision Servers can provide geo-fencing and geo-tracking features and can enhance dxMasterNode capabilities for some use cases. Registry Nodes can manage the discovery of nodes and the registration of new servers along with federating reputation data for use by the master node and the storage node networks. Charge Processing and Accounting nodes can facilitate in-container commerce by managing payment operations within containers as required by the dxMasterNode network.

In some implementations, there can be two types of users within the dxChain environment: Information Owners, who can store and distribute data, and End Users, who can be recipients of Information Owner data. Both parties can create accounts using tools, applications, and/or portals that connect to the dxChain Network. As not all content on the dxChain Network can have rights management permissioning that can require identity of recipients to be known, it is possible that some recipients of information from the network can use dxContainers without having an account.

In some implementations, users creating storage accounts can be asked to verify their email address and phone number. In some implementations, accounts can be created using a username and password, but because it costs currency to create accounts, it can be desired that all accounts can be verified by the dxMasterNodes prior to approval on the network. This can allow the dxMasterNodes to fulfill their responsibilities as registration authorities to the network. After their email address and phone number have been verified, the account can be added to a waiting list, from which users can be notified by email once their accounts have been approved.

In some implementations, registration against the network can occur using an initial key pair. Uploading the public key with a password to the service can be sufficient to create a unique identifier. For the purpose of creating applications that use dxChain security as part of a broad community or application, a user account can additionally include a username, a real name, and/or other identity data when it is stored to the credential region of the dxMasterNode network.

In some implementations, upon receiving notification of their account being approved, users can click on the link in the email to finish the account creation process. Passwords can be stored internally, for example, as hash of a variety of user characteristics. As a result, passwords cannot be recoverable.

In some implementations, identity within dXChain can be managed using compatible X509v3 certificates to support identity and account use within the system for users, organizations, systems, and/or software that seek to use the dxChain network. In some implementations, dxChain can seek to integrate with third party IaaS services, including Facebook, Google+, Civic, as well as enterprise directories, U2F services and/or the like.

In some implementations, clients interact with the network through a dxClient application that can be a hybrid wallet and viewer. The dxClient application can manage keys, manage repository storage data, manage rights managed data, manage community for sharing rights managed data, and/or the like. In some implementations, the activities on the wallet can be fully compliant with Tor, with I2P support pending, and/or the like. Location-enabling services cannot work with Tor exit nodes, and dxContainers that rely on location as a characteristic for determining access cannot work in these settings. In some implementations, the Wallet and Viewer applications can be separate components of the dxClient and, therefore, can be deployed independently. For specialized IoT deployments, the Viewer can be deployed as a certified proxy that works against the dxChain network.

In some implementations, DXC plugins can be developed for common hardware and software-based wallet solutions to provide users with added security for keys in traditional wallet environments. In some implementations, the dxClient and Wallets can be private, to facilitate the sharing and assignment of rights within the dxChain infrastructure. Private wallets can be known publicly with associated identities; unlike other platforms that do share wallet information. The dxChain cannot share the balances (ex: DXE, DXC, and DXP) of accounts, with other users, as these things can be known only to the dxMasterNode network.

In some implementations, the dxPortal is envisioned as a web-based alternative for account management features provided on the dxChain Network. In some implementations, the dxChain can provide protections for content such that Information Owners can control one or more of the following: view, print, copy/paste, screen capture, or extract their data; set Valid Times for information access; identify other dxChain users who can access their data from a common address book in the dxChain; specify general or specific geographic constraints that bound information content access; specify prices for access to perform actions against received content.

In some implementations, the dxMasterNodes can provide community approved templates for different types of information that Information Owners can choose. Information can be controlled, tracked, and managed using the normalized metadata of these templates.

In some implementations, the dxChain can be written using methods that establish security against quantum computing methodologies that can prove future vulnerabilities to asymmetric cryptography. The dxChain can achieve this goal by using mechanisms that include one or more of the following: algorithms for asymmetric cryptography that are known to be quantum resistant; seeding true random number seeds for all symmetric and asymmetric cryptographic tasks; managing the rotations of private keys to ensure that heavy use of signatures do not belie underlying private key values, and/or the like. The dxServiceNodes can provide services back to dxMasterNodes to ensure the availability of quantum random number sources into the dxChain cryptosystem.

In some implementations, overcoming issues of trust is a challenge for the dxChain Network. Specifically, it is important to establish that node is aligned to its role. The dxChain Network must overcome issues of trust in one or more ways. For example, the dxChain Network can trust in the availability and legitimacy of storage on the network by Information Owners and trust in the Information Owners' ability and willingness to pay by the dxStorageNodes. For example, the dxChain Network can trust that the Information Owner consent will be respected by End Users and that activities will be accurately tracked and managed in alignment with the Information Owner's consent.

In absence of trust, nodes on the dxChain Network can rely on consensus using facts they know to prove independently results attested to by other network participants. This consensus can form the backbone for behavioral norms on the network that helps to establish reputation and lower costs associated with validation and coordination.

In some implementations, the dxChain can use consensus techniques to create trust between nodes. For example, at the storage level, consensus is enforced using a Proof-of-Work (POW) regime to demonstrate that data has been correctly been appended to underlying blocks. In blockchains, transactions can be immutable and irreversible because every block can be stamped with the solution of a cryptographical problem. POW can secure the blockchain because to revert a transaction, a malicious attacker would need more work capacity than the rest of the network combined.

In some implementations, POW can allow for control of mining power to change over time as demand for the use of the dxChain network grows. This approach can allow the network protection from malicious behavior where a malicious participant could potentially get control of the network; using investments of computing power and electricity, malicious actors can be outperformed by honest miners. This is different from Proof-of-Stake, where a malicious miner who holds 51% of currency cannot be overcome by the rest of the network.

In some implementations, dxStorageNodes demonstrate that they are storing the files uploaded by the Information Owners with a mechanism called Proof of Storage (POS). The dxMasterNodes can submit to the blockchain small fragments of the Information Owner's file during the file contract span, and the blockchain autonomously decides by the end of the contract if the uptime requirement has been fulfilled.

In some implementations, dxStorageNodes can demonstrate they have capacity to perform storage tasks using Proof of Availability (POA). As part of the file contracting process, dxStorageNodes can advertise the availability of storage, to dxMasterNodes.

In some implementations, burning tokens can include assigning them to an address that is unusable, effectively retiring those tokens from circulation. The dxServiceNodes can have to burn a certain amount of DXM in order to prove they are legitimate participants in the network. The result can be a deflationary effect on the overall currency network.

Proof of Deletion can be the process by which dxStorageNodes attest to the dxMasterNodes that they have complied with the removal of an Information Owner's content. In some implementations, distributed Byzantine Fault Tolerance (DBFT) can be used to develop consensus between dxMasterNodes. DBFT can require a dxMasterNode to be nominated at random to build blocks for consensus by the dxMasterNodes. Once built, the block calculation can be voted as correct by 67% of the remaining dxMasterNodes for the block to be considered correctly appended to the chain.

In some implementations, nominations for project work and improvements can be facilitated through the dxFoundation. The dxMasterNodes can have the ability to nominate changes and improvements and vote for scheduling and priorities that are considered to improve the dxChain environment. Ricardian Contracts can be used throughout the dxChain environment. These contracts can take the form of File Contracts, Privacy Assignments, Access Agreements, and Notification Agreements that enable the dxChain system to work.

In some implementations, Ricardian Contracts are both human readable and machine readable. Agreements to be executed through collaboration on dxChain, can beunderstood and enforceable beyond dxChain. These contracts can be different from smart contracts in that smart contracts are executables that can be governed by Ricardian Contracts, but Ricardian Contracts preserve their purpose and meaning beyond the code of a smart contract to be executed. In using this approach, the dxChain contracts are described using formal ontologies, which are then used within Ricardian Contracts to legally guarantee validity with the ontologies embedded.

In some implementations, initial applications can be enabled using the dxChain network. In dealing with Supply Chain, blockchain technologies can assist greatly in providing a non-reputable record of attestation regarding the custody and authenticity of products and their components as they are sourced from producers to manufacturers and consumers.

In some implementations, the dxChain containers can provide non-reputable bills of lading; can secure specifications and invoices for confidential transfers and shipments beyond the initial point of receipt; can late-bind consitutents to the sharing or access to data not initially contemplated by smart contracts that might be otherwise used for custodial release; can deliver executable instructions to IoT devices and other devices on the network; can be disabled when data is attempted access from unidentified networks or outside given time parameters, and/or the like.

In some implementations, consumer purchase records can be stored on blockchain easily today. Posting reasonably anonymized consumer data, consumers can share information stored on these chains with retailers in return for compensation. Data exchange between consumer mobile devices and retailer IoT environments can be used to provide a highly custom and engaging shopping experience.

In some implementations, dxContainers can allow full purchase histories and other data to be fully controlled by the consumer in a consumer retail environment; allow consumer to sell their data access on either a temporary or permanent basis to retail environments to better help facilitate access to their content; reduce time for retailers in identifying appropriate targeted opportunities for resale, and/or the like.

Blockchain can provide permissioned access to reasonable amounts of consumer data. In some implementations, consumers can advertise the value of their data without revealing its content, content can be leased to restaurants for an enhanced diner experience, custom applications can match consumer preferences with menu options or ingredient substitutions, and/or the like. Consumer data cannot reside at the restaurant.

In some implementations, dxContainers can store vehicle service records, maintain off-chain non-repudiation of official documents and appraisals, hold documents certifying provenance and custody, provide a safe mechanism for sharing independently of the blockchain mechanism (e.g., persistently protected regardless of how or from where they are accessed), and/or the like

Enterprise rights management systems can enforce custody of documents on corporate networks. In some implementations, dxContainers can control the circulation of static data to ensure that files can only be used from within a corporate network, provide consistent alerting and tracking for all distributed assets, easily add users to access control lists, disable assets that have been lost or mishandled, and/or the like.

In some implementations, dxChain can be used as the foundation for secure chat and messaging applications, as well as photo sharing and social networking platforms, where content can be easily time-boxed. The dxChain can provide opportunities to package and sell content. The dxChain can provide for the distribution of sealed executables that can operate against either other dxChain containers or within the scope of the user wallet, collecting and processing data within a VM sandbox.

In some implementations, the dxFoundation can be established as a non-profit organization that can be established by dxChain. Until then, dxChain can provide the functions required that the dxFoundation is required to fulfill. Governance to automated systems can be migrated empowering users and stakeholders with direct influence and control over the network and its development. Community consensus can be developed through the voting of major stakeholders is common to other tokens, including Dash and Steemit.

In some implementations, it is anticipated that dxFoundation and its work can be paid through the dxChain mining system on an ongoing basis. By all members being paid through the activities of dxChain, the dxFoundation cannot be reliant on soliciting operating funds from either dxMasterNode holders or other potentially interested parties in the form of sponsorships or donations, which have potential to create conflicts of interest. A percentage (e.g., 5%) of the block rewards and other revenues can go directly to dxFoundation funding.

In some implementations, each dxMasterNode operator can receives one vote. If there are more proposals that meet that criteria than there are budget funds for the month, then the proposals with the highest number of net votes can be paid. Community interaction with proposal submitters is done through the dxChain forums and/or through community-driven websites. These websites can allow proposal submitters to provide multiple drafts, then lobby for community support before finally submitting their project to the network for a vote.

The dxFoundation can provide education about the use and applications that can be developed using dxChain. The dxFoundation can support the development of consensus among its members regarding improvements and changes to the dxChain network. The dxFoundation can provide consistent and normalized auditing of all dxMasterNodes and services provided to the network. The dxFoundation can carry the first global insurance policy for maintaining the privacy and protection of identity for the records and information stored and distributed. The dxFoundation can provide development support to all users of the DXC token. The dxFoundation can provide support for improvement of the DXC platform through the performance of a bug bounty which can pay a share of its reserve to parties finding defects in contemplated and active distributions of dxChain Network code. The dXFoundation can engage in strategic acquisitions and investments to ensure the vitality of team and ongoing improvement to the technology. The dxFoundation can engage in commercial software licensing that improves the integrity of the network, its security, and/or applications. The dxFoundation network governance can be managed by dxChain as an entity, and can be migrated to a more representative form that can better empower stakeholders and/or users. The dxFoundation can commit itself to the protection of its users and/or their identities. A portion of dxFoundation funding can be applied to causes and/or vendors, who, through partnership, help protect personal data privacy, identity, and/or the assertion of freedom online.

In some implementations, dxChain can envision a number of paths to the market. Effectively, dxChain can allow for the enforcement of privacy and/or secure distribution of content broadly. The dxChain can provide a clear view of the type of capabilities that dxChain can enable. Additionally, the dxChain user base can be grown using one or more of the following approaches: reward users from the beginning for storing and controlling data, incentivize alliance businesses with the proceeds of our ICO through the work of the dxFoundation, support and expand into verticals, and/or the like.

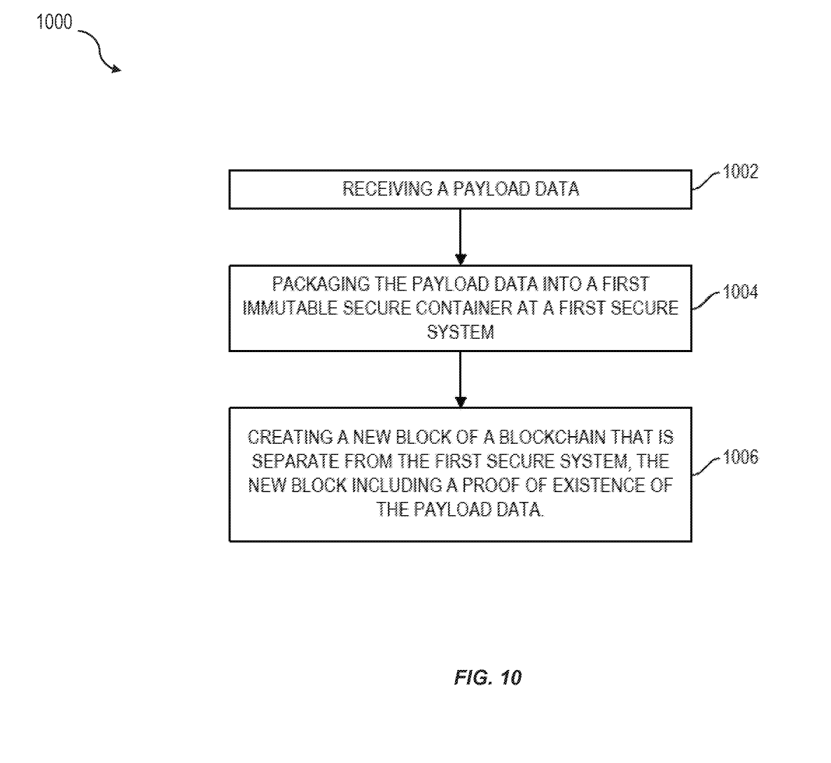

FIG. 10 is a flow chart of an exemplary method for storing data in a dxChain network. At 1002, payload data can be received. The payload data can be generated by dxClient. For example, the payload data can be encrypted (e.g., in the form of a dxContainer 202). The encrypted payload data can include one or more of a payload metadata (e.g., content metadata), payload right management specification (e.g., rights management specification) and a plurality of payload data packets (e.g., secure content holding).

At 1004, the payload data can be packaged into a first immutable secure container at a first secure system. At 1006, a new block of a blockchain that is separate from the first secure system can be created. The new block can include a proof of existence of the payload data.

Certain exemplary embodiments will now be described to provide an overall understanding of the principles of the structure, function, manufacture, and use of the systems, devices, and methods disclosed herein. One or more examples of these embodiments are illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web interface through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, can be applied to modify any quantitative representation that could permissibly vary without resulting in a change in the basic function to which it is related. Accordingly, a value modified by a term or terms, such as “about” and “substantially,” are not to be limited to the precise value specified. In at least some instances, the approximating language can correspond to the precision of an instrument for measuring the value. Here and throughout the specification and claims, range limitations can be combined and/or interchanged, such ranges are identified and include all the sub-ranges contained therein unless context or language indicates otherwise.

What is claimed is:

1. A method comprising:
receiving a payload data;
packaging the payload data into a first immutable secure container at a first secure system; and
creating a new block of a blockchain that is separate from the first secure system, the new block including a proof of existence of the payload data.

2. The method of claim 1, wherein the payload data is encrypted prior to storage at the first secure system.

3. The method of claim 1, wherein the proof of existence of the payload data includes a signature, an identifier, and a location of the first immutable secure container.

4. The method of claim 1, wherein the first immutable secure container includes content metadata, a rights management specification, and at least one secure content holding including the payload data.

5. The method of claim 1, wherein the first secure system includes an access policy associated with the first immutable secure container.

6. The method of claim 1, wherein the payload data is received by a first master node, the method further comprising:
selecting, by the first master node, a first storage node from a plurality of storage nodes, the first storage node configured to store at least a first portion of the payload data;
storing, by the first master node, the first portion of the payload data in the first storage node; and
generating, by the first master node, a first assignment indicative of the first storage node.

7. The method of claim 6, wherein the first master node receives a plurality of bids from the plurality of storage nodes, wherein a first bid from the first storage node is indicative of a token associated with the first storage node.

8. The method of claim 7, further comprising,
storing, by the first master node, a second portion of the payload data in a second storage node of the plurality of storage nodes, wherein the first portion of the payload data includes a first payload datapacket of the plurality of payload datapackets and the second portion of the payload data includes a second payload datapacket of the plurality of payload datapackets;
generating, by the first master node, a second assignment indicative of the second storage node; and
generating, by a second master node, a pointer indicative of the first master node.

9. A system comprising:
at least one data processor;
memory coupled to the at least one data processor, the memory storing instructions to cause the at least one data processor to perform operations comprising:
receiving a payload data;
packaging the payload data into a first immutable secure container at a first secure system;
creating a new block of a blockchain that is separate from the first secure system, the new block including a proof of existence of the payload data.

10. The system of claim 9, wherein the payload data is encrypted prior to storage at the first secure system.

11. The system of claim 9, wherein the proof of existence of the payload data includes a signature, an identifier, and a location of the first immutable secure container.

12. The system of claim 9, wherein the first immutable secure container includes content metadata, a rights management specification, and at least one secure content holding including the payload data.

13. The system of claim 9, wherein the first secure system includes an access policy associated with the first immutable secure container.

14. The system of claim 9, further comprising:
a plurality of storage nodes including a first storage node configured to store at least a first portion of the payload data;
a first master node configured to perform operations comprising:
receiving the payload data;
selecting the first storage node from the plurality of storage nodes;
storing the first portion of the payload data in the first storage node; and
generating a first assignment indicative of the first storage node.

15. The system of claim 14, wherein the first master node receives a plurality of bids from the plurality of storage nodes, wherein a first bid from the first storage node is indicative of a token associated with the first storage node.

16. The system of claim 15, further comprising:
a second master node;
wherein the plurality of storage nodes further includes a second storage node configured to store at least a second portion of the payload data, wherein the first master node is further configured to perform operations comprising:
storing the second portion of the payload data in the second storage node, wherein the first portion of the payload data includes a first payload datapacket of a plurality of payload datapackets and the second portion of the payload data includes a second payload datapacket of the plurality of payload datapackets;
generating a second assignment indicative of the second storage node; and
wherein the second master node is configured to perform operations comprising:
generating a pointer indicative of the first master node.

17. A computer program product comprising a non-transitory machine-readable medium storing instructions that, when executed by at least one programmable processor that comprises at least one physical core and a plurality of logical cores, cause the at least one programmable processor to perform operations comprising:
receiving a payload data;
packaging the payload data into a first immutable secure container at a first secure system;
creating a new block of a blockchain that is separate from the first secure system, the new block including a proof of existence of the payload data.

18. The computer program product of claim 17, wherein the first master node receives a plurality of bids from the plurality of storage nodes, wherein a first bid from the first storage node is indicative of a token associated with the first storage node.

19. The computer program product of claim 18, wherein the payload data is received by a first master node, wherein the non-transitory machine-readable medium is further storing instructions that, when executed by the at least one programmable processor, cause the at least one programmable processor to perform operations comprising:
selecting, by the first master node, a first storage node from a plurality of storage nodes, the first storage node configured to store at least a first portion of the payload data;
storing, by the first master node, the first portion of the payload data in the first storage node; and
generating, by the first master node, a first assignment indicative of the first storage node.

20. The computer program product of claim 18, wherein the non-transitory machine-readable medium is further storing instructions that, when executed by the at least one programmable processor, cause the at least one programmable processor to perform operations comprising:
storing, by the first master node, a second portion of the payload data in a second storage node of the plurality of storage nodes, wherein the first portion of the payload data includes a first payload datapacket of the plurality of payload datapackets and the second portion of the payload data includes a second payload datapacket of the plurality of payload datapackets;
generating, by the first master node, a second assignment indicative of the second storage node; and
generating, by a second master node, a pointer indicative of the first master node.
